(19) United States
(12) Patent Application Publication
(10) Pub. No.: US 2004/0148598 A1
(43) Pub. Date: Jul. 29, 2004

(54) Apparatus for the method of providing software product information, and computer program product

(75) Inventors: Aki Kita, Kawasaki (JP); Toshiharu Kido, Inagi (JP); Tsutomu Tomomatsu, Kawasaki (JP); Masato Ageta, Kawasaki (JP); Mikiko Kimura, Kawasaki (JP); Akihiro Shimaya, Kawasaki (JP); Yuichi Maruyama, Kawasaki (JP); Noriko Hozumi, Inagi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/740,540

(22) Filed: Dec. 22, 2003

(30) Foreign Application Priority Data
Jan. 23, 2003 (JP) 2003-015117

(51) Int. Cl. G06F 9/44; G06F 9/445

(52) U.S. Cl. 717/170; 717/171; 717/176

(57) ABSTRACT

An apparatus for providing software information includes an acquiring unit that acquires software information concerning at least one of a software product used in the computer and a suitable software product for the computer; and a providing unit that provides the software information to a computer that is connected to the apparatus via a network.

### BACKGROUND OF THE INVENTION

1) Field of the Invention

The present invention relates to a technology for providing software information to a user's computer via a network.

2) Description of the Related Art

Most of the computers are pre-installed with various software products before shipment from the factory or before sales by the dealer. Such software products (hereinafter, “pre-installed software products”) are selected by manufacturers of the computers so as to reliably operate in the computers.

However, it is a normal practice for a user to operate software products (hereinafter, “commercial software products”) other than the pre-installed software products. Concretely, the user purchases an upgraded version of the pre-installed software product or a commercial software product on the Internet or in shops, and installs the commercial software product in user's computer.

The software dealers advertise new software products or new versions of software products together with explanation of recommended specifications and new functions, for example in magazines and on World Wide Web sites. Such explanation is useful to prevent the user from purchasing an unwanted software product as well as a software product not operated in user's computer.

However, when there is a plurality of upgraded versions of software, it is difficult for the user to decide which software product is proper.

Upgrading of versions includes: an upgrading of version from a version having limited functions for trial purpose to an approved version for normal use; an upgrading of version of an old software product to a new version; an upgrading of version from a package having a number of software products to a package having increased number of software products; and an upgrading of version by using other manufacturer's software product. Thus, there are various kinds of upgraded versions and it is difficult for a user to choose the upgraded version that is suitable to the user's software license.

Moreover, since the explanation in magazines or on Web sites is for a general user and not for a specific user, the user needs time to make sure of the upgraded version that is sought. This, sometimes, may result in losing user's interest in buying the upgraded version.

When the user purchases a new software product, the computer function may not fulfill the recommended specifications of the new software product and the new software product may not be used effectively.

Thus, when the user wishes to buy an upgraded version of software product or a new software product, the selection of the software becomes difficult. Therefore, providing the software information efficiently to the user is an issue of utmost importance. A distribution management apparatus of software that is also subjected to upgrading of version is disclosed in Japanese Patent Application Laid-open Publication No. 2000-29672. However, the problems in the conventional technology cannot be solved even by this patent document.

“Network VAIO Hotnetwork service” retrieved on Jan. 15, 2003, Internet URL: http://www.jp.sonystyle.com/Hotnetwork/Details/ud.html discloses another conventional art. According to the conventional art, the system scan is performed in a user's computer and the scan result is transmitted to a server. The server provides a required upload program to the user's computer. The upload program is, for example, a patch program or an upgraded program, of basic input output system (BIOS), operating system (OS), and a device driver, so that the user's computer operates normally. However, in this conventional art, only the program having the guaranteed operation is provided. In other words, it is unable to select a suitable product from multiple versions of software products which operate in the user's computer.

### SUMMARY OF THE INVENTION

It is an object of the present invention to at least solve the problems in the conventional technology.

An apparatus for providing software information according to one aspect of the present invention is connected to a computer via a network. The apparatus includes an acquiring unit that acquires software information concerning at least one of a software product used in the computer and a suitable software product for the computer; and a providing unit that provides the software information to the computer.

A method of providing software information to a computer via a network, according to another aspect of the present invention, includes acquiring software information concerning at least one of a software product used in the computer and a suitable software product for the computer; and providing the software information to the computer.

The computer program product according to another still aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a functional block diagram of a software information providing system according to the present embodiment;

FIG. 2 is an example of model data;

FIG. 3 is an example of user data;

FIG. 4 is an example of product data;

FIG. 5 is an example of a display of software information;

FIG. 6 is a flow chart of a processing procedure of a product information extractor;

FIG. 7A is an example of tabular management of software purchase history; and

FIG. 7B is another example of a display of software information.

### DETAILED DESCRIPTION

Exemplary embodiments of software information providing apparatus, method of providing software information, and computer program relating to the present invention will be explained in detail below with reference to the accompanying drawings. The present embodiment is mainly for a case of providing software information on the Internet Web.

Like reference characters designate corresponding parts in the several views.

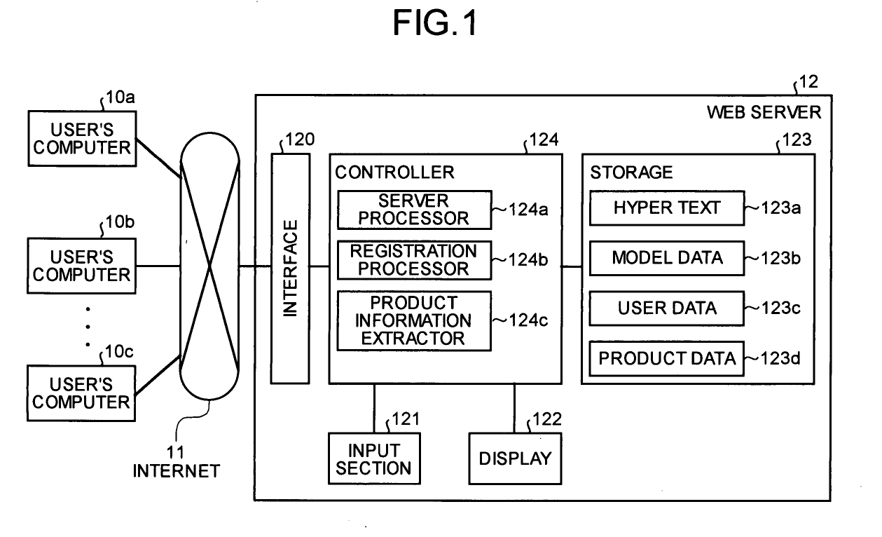

FIG. 1 is a functional block diagram of a software information providing system that includes a software information providing apparatus according to the present invention. As is shown in FIG. 1, in this system, user's computers 10a, 10b, and 10c are connected to a WEB server 12 via the Internet 11.

The user's computers 10a, 10b, and 10c are machines installed with a WEB browser. The WEB browser enables an access to a HyperText Transfer Protocol (HTTP) server. The user's computers 10a, 10b, and 10c can make an access to all servers on the Internet via a provider.

The WEB server 12 corresponds to the software information providing apparatus in the present invention. The WEB server 12 is the HTTP server that is accessed by the user's computers 10a, 10b, and 10c on the Internet 11 and provides web services.

The WEB server 12 provides not only general web services but also valuable software information to all users of the user's computers 10a, 10b, and 10c, efficiently. Concretely, according to new release of upgraded software product or new software product, software information that is customized for the user's computers 10a, 10b, and 10c is provided. Thus, the complicated job for selection of software product by the user is simplified, thereby encouraging the purchase of the software product.

As is shown in FIG. 1, the WEB server 12 includes an interface 120, an input section 121, a display 122, a storage 123, and a controller 124. The interface 120 is a network interface that communicates with the user's computers 10a, 10b, and 10c via the Internet 11. Concretely, the interface 120 performs processing according to the Transmission Control Protocol/Internet Protocol (TCP/IP). The WEB server 12 is a known computer that includes a CPU, a memory, a hard disc. A computer program according to the present invention is loaded in the memory and controls the CPU. The computer program realizes a server processor 124a, a registration processor 124b, and a product information extractor 124c in the controller 124.

The input section 121 is an input device like a keyboard or a mouse. The display 122 is a display device like a liquid crystal panel. The storage 123 is a storage device like hard disc, and has a hypertext 123a, model data 123b, user data 123c, and product data 123d stored in it.

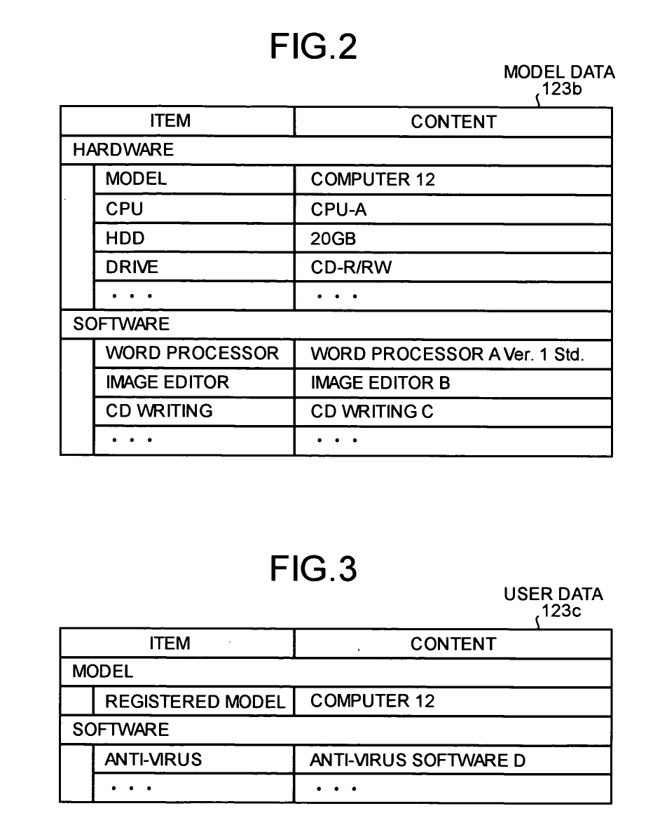

The hypertext 123a is transmitted to the user's computers 10a, 10b, and 10c, and forms a display screen on the WEB browser of them. The model data 123b includes hardware information and software information for each model of computer. FIG. 2 is an example of the model data 123b. The hardware information shown in FIG. 2 includes a model name “COMPUTER 12” and its specifications, for example, CPU “CPU-A”, hard disc capacity “20 G”, and a drive “CD-R/RW”. The software information shown in FIG. 2 includes a word processor software “WORD PROCESSOR A Ver. 1 Std.” that is a pre-installed software product, an image editing software “IMAGE EDITOR B”, a CD writing software “CD writing C”. Thus, just by knowing the model that is used by the user, the information of, specifications and the pre-installed software products can be obtained.

The user data 123c includes information of computer model used by the user and software information indicating software products (excluding the pre-installed software product) that are purchased by the user. FIG. 3 is an example of the user data 123c. As is shown in FIG. 3, the information of computer model includes the name of a registered model (e.g., COMPUTER 12). The software information shown in FIG. 3 includes a name of anti-virus software “D” that is purchased by the user. Thus, by tracing the model data 123b based on the information of computer model, information of the specifications and the pre-installed software products can be obtained. In addition to this, from the software information of the user data 123c, the software products purchased by the user other than the pre-installed software product can be known.

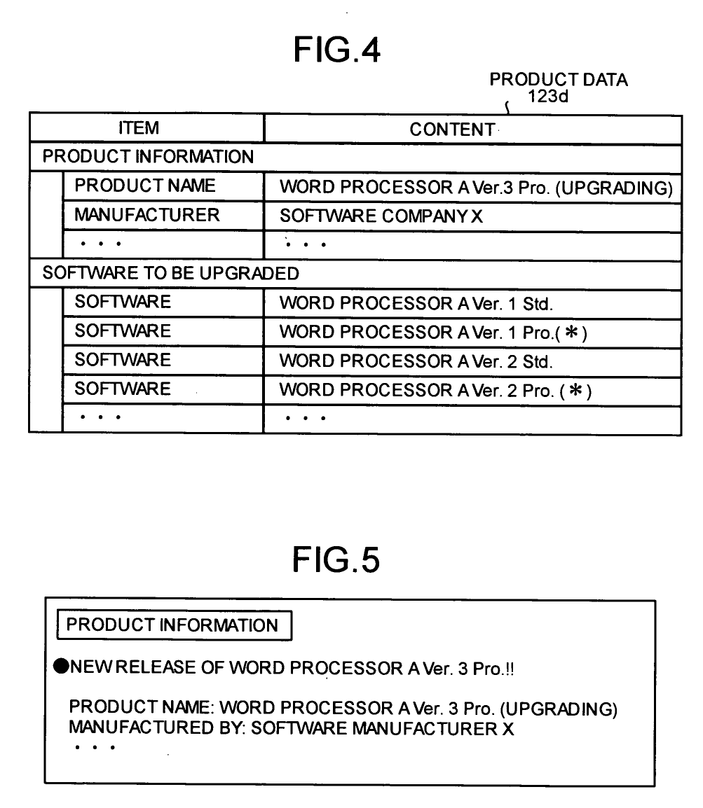

The product data 123d includes product information of a commercial software product and other software products that are allowed to be upgraded to the commercial software product. FIG. 4 is an example of the product data 123d. The product information shown in FIG. 4 includes a product name (e.g., WORD PROCESSOR A Ver. 3 Pro.), and name of the manufacturer. The software product subjected to upgrading includes a name (e.g., WORD PROCESSOR A Ver. 1 Std., WORD PROCESSOR A Ver. 1 Pro., WORD PROCESSOR A Ver. 2 Std., and WORD PROCESSOR A Ver. 2 Pro.) of the old version of software product that is necessary for upgrading the version of this product. The software product marked with an asterisk after the name in FIG. 4 is a software product recommended by the manufacturer. Thus, by using the product data 123d, the software subjected to upgrading of version can be specified from the product name.

The controller 124 controls the WEB server 12 and includes the server processor 124a, the registration processor 124b, and the product information extractor 124c. The server processor 124a functions as an HTTP server for the user's computers 10a, 10b, and 10c. Concretely, the server processor 124a, when accessed by the user's computers 10a, 10b, and 10c, reads out the hypertext 123a and transmits the hypertext 123a to the corresponding user's computer among the user's computers 10a, 10b, and 10c.

The registration processor 124b, jointly with the server processor 124a performs registration processing of the model data 123b, the user data 123c and the product data 123d. Concretely, a page for registration processing is prepared on a web page that is provided by the server processor 124a. When data is input on the web page, the input result is reflected in the model data 123b, the user data 123c, and the product data 123d. When the input result is reflected, registration of the model data 123b is performed mainly by a system administrator, registration of the user data 123 is performed by the user, and registration of the product data is mainly performed by the software manufacturer. The data registration may be performed automatically by joint action (data transfer) of the user's computers 10a, 10b, and 10c and a manufacturer's server, instead of by using the page for the registration processing.

The product information extractor automatically extracts the product information that is suitable to the hardware and the software of the user's computers 10a, 10b, and 10c possessed by users. For example, since a user who has the user data 123c shown in FIG. 3 uses COMPUTER 12, it is revealed that the user possesses Word Processor A Ver. 1 Std. as a pre-installed software in the user's computer. The product WORD PROCESSOR A Ver. 3 Pro. shown in FIG. 4 is a software product subjected to upgrading of version of Word Processor A Ver. 1 Std. Thus, the product information extractor 124c includes information relevant to WORD PROCESSOR A Ver. 1 Std. in the software information of the user that has the user data 123c.

The product information extractor 124c extracts the software information of each user and converts it into a hypertext in advance. When the user makes an access to the web page, the product information extractor 124c displays the software information for the corresponding user on the web page. FIG. 5 is an example (only a corresponding part) of a display of software information. As is shown in FIG. 5, “New Release of Word Processor A Ver. 3 Pro. !!” is displayed as the product information.

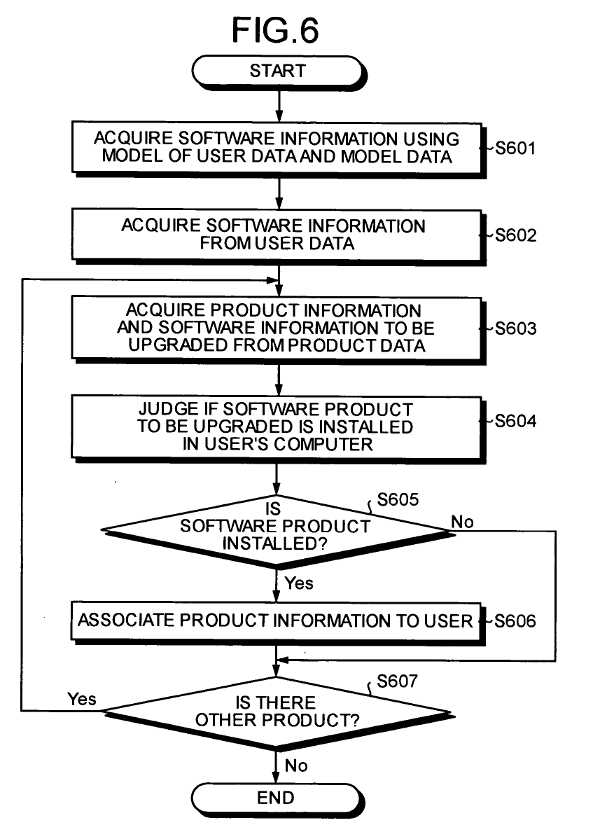

Following is the description of a processing procedure of the product information extractor that is shown in FIG. 1. FIG. 6 is a flow chart of the processing procedure of the product information extractor 124c that is shown in FIG. 1. For convenience, only a case of extraction of information for user AAA that has the user's computer 10a is mentioned here.

As is shown in FIG. 6, in the product information extractor 124c, the user's model is fetched from the user data 123a of the user AAA. The software information (of the pre-installed software product) is fetched from the model data 123b of the user's model (step S601). The software information (other than the information of the pre-installed software product) of the user data 123c is fetched (step S602). All software products that are installed in the user's computer 10a are specified.

To specify a user that makes an access to the web page provided by the WEB server 12, a known identity (hereinafter, “ID”) management may be used. In other words, a peculiar ID is assigned to the user in advance. When the user inputs the ID while making an access to the web page, the WEB server 12 can identify the user that has made an access. Further, by registering the ID as an item in the user data in FIG. 3, the user data corresponding to the user can be specified by using the ID that is input by the user.

Then the product information and the software product subjected to upgrading of version are acquired from the product data 123d (step S603) and judgment of whether the user AAA has any one of the software product to be upgraded is made (step S604).

When the user AAA has any one of the software product to be upgraded (step S605), a corresponding software product is associated with the user AAA and investigation of whether there is any other product is carried out (step S607). If any other project is there (step S607 affirmation), the process returns to step S603 and similar process is repeated. If there is no other product (step S607), the process ends.

The server processor 124a, thus, inserts the information that is extracted and formed by the product information extractor 124c into the hypertext 123a and provides this information to the user's computer 10a that makes an access. Thus, customized product information corresponding to an environment of the user that uses the user's computer 10a is displayed in the WEB browser of the user's computer 10a.

By performing a series of processes, the software information of a software product that is suitable to the user can be extracted in advance and can be provided to the user when the user makes an access.

Thus, in the present embodiment, the information of a pre-installed software product is registered by the registration processor 124b as the model data 123b for each model. The information of user's computer model and the software product other than the pre-installed software product are registered by the registration processor 124b as the user data 123c. The product information of the software product (i.e., the software product and software products that are subjected to upgrading) is registered by the registration processor 124b as the product data 123d by. The product information extractor 124c extracts and provides the software product that is suitable for the user. Due to such structure, each user can have customized software information. Thus, the complicated job of software product selection by the user is simplified, thereby encouraging the purchase of software product.

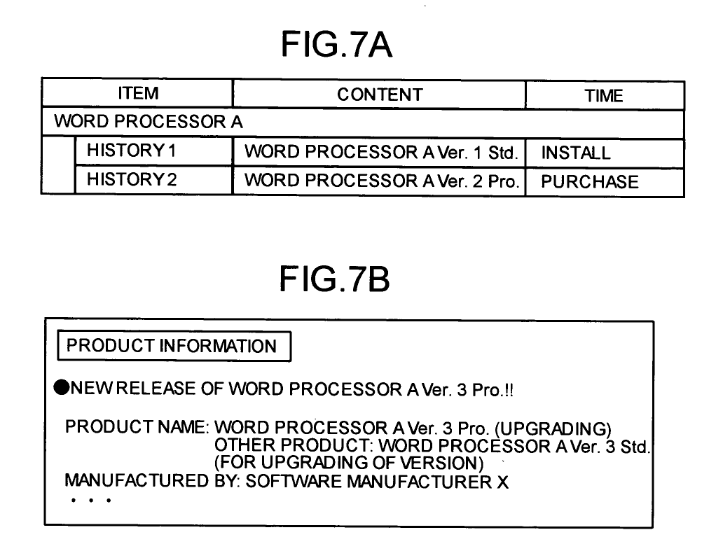

In the present embodiment, the process till the extraction and providing of the software information has been described. Moreover, as is shown in FIG. 7A, history of software purchase by each user can be maintained in a tabular form. The product information extractor 124c can select a sort of the software product elaborately by referring to the table as is shown in FIG. 7B. According to this example, WORD PROCESSOR A Ver. 1 Std. has already been installed and WORD PROCESSOR A Ver. 2 Pro. is purchased later. For this reason, as is shown in FIG. 7B, when WORD PROCESSOR Ver. 3 is to be purchased later, the professional version (Pro.) is given priority and not the standard version (Std.). Furthermore, if Word Processor A Ver. 2 Std. is purchased after this, the standard version (Std.) is given priority over the professional version (Pro.).

In the present embodiment, extraction of a product based on only the information of software product that is installed by the user by the product information extractor 124c is mentioned. It is also possible to have a structure in which the product information extractor 124c extracts a product based on software information as well as hardware. Concretely, to execute the software product smoothly, it is necessary to fulfill the recommended specifications regarding the computer function. For example, it is indispensable for a software product driving a CD-R/RW drive that the CD-R/RW drive is provided as hardware.

Further, in the present embodiment, the software information is extracted in advance for each user and when an access is made by the user from the user's computers 10a, 10b, and 10c, the software information is provided. It is also possible to extract software information that is suitable for the user whenever an access is made.

The software information is provided on web page (using HTTP) as described above. However, the present invention is not restricted to this case only and the software information can also be provided using simple mail transfer protocol (SMTP) or network news transfer protocol (NNTP). For example, in a case of providing the software information by using e-mail, the WEB server 12 is equipped with a function to transmit e-mails to users of the user's computers 10a, 10b, and 10c and the software information may be transmitted by e-mail.

In the present embodiment, the WEB server 12 includes the input section 121 and the display 122. However, this structure is not indispensable. When the WEB server 12 does not include the input section 121 and the display 122, the system administrator can make an access to the WEB server 12 by using a user's computer that has an input section and a display, and necessary data may be registered.

Thus, according to the present invention, each user can obtain customized software information that is suitable to license of software product that is installed by the user and the hardware in user's computer. In this way, the complicated job of software product selection by the user is simplified, thereby encouraging the purchase of software. Particularly, when there is a plurality of upgraded versions of software product, the information of software product that is selected according to software purchase history by the user in the past is extracted as the software information. This enables to provide the most suitable software information based on the software purchase history (history of upgrading of version) by the user.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing software information, the apparatus being connected to a computer via a network, comprising:
an acquiring unit that acquires software information concerning at least one of a software product used in the computer and a suitable software product for the computer; and
a providing unit that provides the software information to the computer.

2. The apparatus according to claim 1, wherein the acquiring unit acquires information concerning the software product used, from the computer via the network.

3. The apparatus according to claim 1, further comprising:
a storage that stores
computer model data that includes information of specifications of a plurality of computers that are put on a market and a software product pre-installed in the computers,
user data that includes information of a model of the computer and a software product installed in the computer, the software product installed being other than the software product pre-installed, and
product data that includes information of a plurality of software products that are put on a market, wherein
the acquiring unit acquires the software information based on the computer model data, the user data, and the product data.

4. The apparatus according to claim 3, wherein
the computer model data includes information for each of the computers, and
the product data includes information for each of the software products.

5. The apparatus according to claim 1, wherein the acquiring unit acquires information of a version-up software product that upgrades the software product used.

6. The apparatus according to claim 1, wherein the acquiring unit acquires information of one of a plurality of version-up software products that upgrade the software product used, based on software purchase history by a user who uses the computer.

7. The apparatus according to claim 1, wherein the providing unit provides the software information to the computer via the network, using any one of hypertext transfer protocol (HTTP), simple mail transfer protocol (SMTP), and network news transfer protocol (NNTP).

8. A method of providing software information to a computer via a network, comprising:
acquiring software information concerning at least one of a software product used in the computer and a suitable software product for the computer; and
providing the software information to the computer.

9. The method according to claim 8, the acquiring includes acquiring information concerning the software product used from the computer via the network.

10. The method according to claim 8, wherein the acquiring includes acquiring information concerning the software product used, from the computer via the network.

11. The method according to claim 10, further comprising:
storing computer model data that includes information of specifications of a plurality of computers that are put on a market and software products pre-installed in the computers,
user data that includes information of a model of the computer and a software product installed in the computer, the software product installed being other than the software product pre-installed, and
product data that includes information of a plurality of software products that are put on a market, wherein
the acquiring includes acquiring the software information based on the computer model data, the user data, and the product data.

12. The method according to claim 11, wherein
the computer model data includes information for each of the computers, and
the product data includes information for each of the software products.

13. The method according to claim 8, wherein the acquiring includes acquiring information of a version-up software product that upgrades the software used.

14. The method according to claim 8, wherein the acquiring includes acquiring information of one of a plurality of version-up software products that upgrade the software product used, based on software purchase history by a user who uses the computer.

15. A computer program product including computer executable instructions stored on a computer readable medium, wherein the instructions, when executed by the computer, cause the computer to perform:
acquiring software information concerning at least one of a software product used in a user computer and a suitable software product for the user computer; and
providing the software information to the user computer via a network.
